(19) United States
(12) Patent Application Publication
(10) Pub. No.: US 2017/0095751 A1
(43) Pub. Date: Apr. 6, 2017

(54) Vacuum Filter Press with High Volume Filter Chambers and Liquid Injection System

(71) Applicant: Daniel J. Simpson, Fernley, NV (US)

(72) Inventor: Daniel J. Simpson, Fernley, NV (US)

(21) Appl. No.: 15/287,669

(22) Filed: Oct. 6, 2016

Related U.S. Application Data
(60) Provisional application No. 62/237,964, filed on Oct. 6, 2015.

(51) Int. Cl. B01D 5/00; B01D 46/00; C02F 1/12; B01D 46/12; C02F 1/06; B01D 1/20

(52) U.S. Cl. CPC B01D 5/0072; B01D 5/006; C02F 1/06; B01D 1/20; C02F 1/12; B01D 46/12; B01D 46/0021; C02F 2103/08

(57) ABSTRACT

A vacuum filter press system may comprise: a frame; a liquid injection system for controllably injecting liquid directly into each of a multiplicity of chambers; a plurality of filter plates configured to form a stack of parallel plates, each of the filter plates being movably attached to the frame and configured to form the multiplicity of chambers, each of the chambers being formed by adjacent filter plates, each of the chambers being lined by filter cloths, wherein the plurality of filter plates, the multiplicity of chambers and the filter cloths are configured to allow water vapor to escape from the chambers while retaining solids from the liquid to form a filter cake; and a vacuum pump connected to the multiplicity of chambers. Furthermore, wherein each filter plate has spacers attached to both sides, for enlarging the width, and hence capacity of the filter chambers.

### CROSS-REFERENCE TO RELATED APPLICATIONS

This application claims the benefit of U.S. Provisional Application No. 62/237,964 filed Oct. 6, 2015, incorporated in its entirety herein.

### FIELD OF THE INVENTION

The invention relates to filter presses and more specifically, although not exclusively, to vacuum filter presses with high volume filter chambers and a liquid injection system.

### BACKGROUND OF THE INVENTION

There is a need for equipment and methods for efficient desalination/salt extraction from brine, particularly on a large commercial scale.

### SUMMARY OF THE INVENTION

Some embodiments of the present invention relate to vacuum filter presses with high capacity filter chambers and a system for controlled injection of brine/liquid directly into each filter chamber, and to methods of desalination/salt extraction using vacuum filter presses of the present invention.

According to aspects of the invention, a vacuum filter press system may comprise: a frame; a liquid injection system for controllably injecting liquid directly into each of a multiplicity of chambers; a plurality of filter plates configured to form a stack of parallel plates, each of the plurality of filter plates being movably attached to the frame, the plurality of filter plates further being configured to form the multiplicity of chambers, each of the multiplicity of chambers being formed by adjacent filter plates of the plurality of filter plates, each of the multiplicity of chambers being lined by filter cloths, wherein the plurality of filter plates, the multiplicity of chambers and the filter cloths are configured to allow vapor to escape from the chambers while retaining solids from the liquid to form a filter cake; and a vacuum pump connected to the multiplicity of chambers.

According to further aspects of the invention, a method of processing liquid in a filter press may comprise: providing a chamber between two filter plates in the filter press, the chamber being lined by filter cloths; vacuum pumping the chamber; during the vacuum pumping, controllably injecting liquid into the chamber causing solids to precipitate from the injected liquid and volatile components to be released in vapor form; removing the vapor from the chamber by vacuum pumping, condensing the vapor and collecting the condensate; and accumulating the solids in the filter chamber and releasing the solids from the filter chamber.

According to further aspects of the invention, a vacuum filter press system comprising: a frame; a plurality of filter plates configured to form a stack of parallel plates, each of the plurality of filter plates being movably attached to the frame, the plurality of filter plates further being configured to form a multiplicity of chambers, each of the multiplicity of chambers being formed by adjacent filter plates of the plurality of filter plates, each of the multiplicity of chambers being lined by filter cloths, wherein the plurality of filter plates, the multiplicity of chambers and the filter cloths are configured to allow vapor to escape from the chambers while retaining solids from the liquid to form a filter cake; and a vacuum pump connected to the multiplicity of chambers; wherein each of the plurality of filter plates has spacers attached to both sides, for enlarging the capacity of each of the multiplicity of chambers.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic of a filter press system with high volume filter chambers and a liquid injection system, according to some embodiments;

FIGS. 2A & 2B are a representation of a partial stack of filter plates, according to some embodiments, shown in vertical cross-section;

FIG. 3 shows a top view of a filter press, according to some embodiments;

FIG. 4 shows a front view of a single filter plate from the stack shown in FIG. 3, according to some embodiments;

FIGS. 5A & 5B show a spacer, highlighting different features, according to some embodiments; and

FIG. 6 shows a schematic of a desalination plant, according to some embodiments.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to some embodiments, a system for desalination of brine/water, such as sea water, geothermal water and brackish water, comprises a vacuum filter press with high capacity filter chambers and an injection system for separately spraying the brine directly into each filter chamber. The injection system may in embodiments be a high pressure, high temperature liquid injection system. The range of temperature and pressure for the liquid injection system may in embodiments be 50 psi to 500 psi and 100° F. to 500° F. (When the filter plates are made of plastics/polymers, the temperature of the chamber should be kept below the softening point of the plastics/polymer material, which is roughly 250° F. in some embodiments; this temperature control may be achieved even when delivering fluids to the chamber which are at a temperature above the softening point, provided that the chamber is kept under a sufficient vacuum while the high temperature and pressure liquid is injected into the chamber.) When the liquid is injected into the chamber the reduced pressure results in at least some of the water being evaporated and some of the dissolved solids precipitating out. Desalinated water is collected by condensing the water vapor—the condensed water vapor is generally referred to as condensate. The salts that precipitate in the chamber are generally referred to as filter cake. Dewatering using the present invention is capable of producing dried filter cake containing less than 10% water by weight, and even less than 1% water by weight.

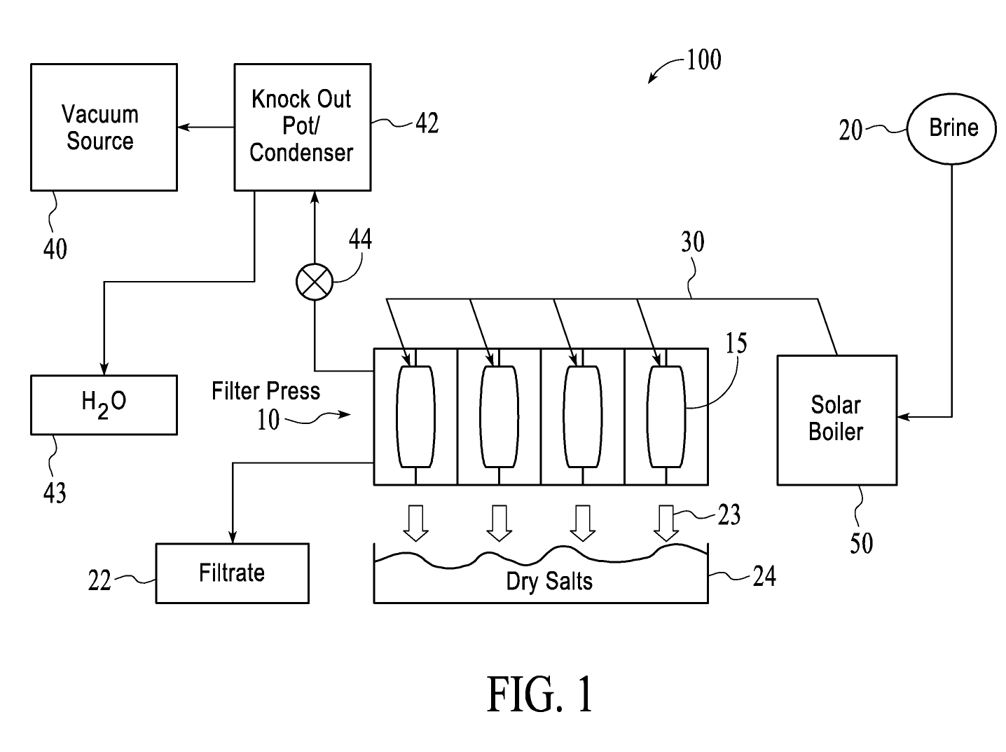

FIG. 1 shows a schematic of a water desalination system 100 including a filter press 10, according to some embodiments of the present invention. FIG. 1 shows a filter press 10 for processing brine 20 to produce a condensate and dry salts 24. The brine is elevated to specified temperature and pressure by a boiler, such as a solar boiler 50 which may include pumps, storage tanks, extra heating capability, etc. The heated brine is then delivered to the filter chambers 15 of the filter press 10 through plumbing 30. On completion of desalination, salts 24 are released from the filter press as indicated by the large arrows. The salts 24 are collected in a tray, on a conveyor belt, or in any other removal device. In this example, brine is described as being fed into the filter press for desalination, however, a wide range of liquids, including sea water, salt water contaminated oil, waste water, etc., may be desalinated using this system. The filter press system includes: vacuum source 40 connected to a knock out pot/condenser 42 and then to the filter press 10 through a valve 44. The vacuum source 40 is used to apply a vacuum to the chambers in the filter press to remove water vapor. The vacuum pump also reduces the boiling point of the liquid in the chambers. The condenser 42 condenses the water vapor removed from the filter press, and the water is collected in a reservoir 43. Any filtrate 22 is collected as shown.

Filter presses include a stack of filter plates, the filter plates are covered by filter cloths, and each pair of filter plates defines a chamber lined with filter cloths into which slurry or other material is fed for dewatering or similar processing. Generally, there will be a stack of N filter plates in a filter press, and M chambers between the plates, where M=N−1 and M and N are integers. However, as described below, in some embodiments the filter chambers have been enlarged to increase the chamber capacity by adding spacers/inserts on either side of each filter plate. Filter plates may be made of plastics materials/polymers with properties commensurate with the needs of the processes being run of the filter press. Filter plates may in embodiments be made of metals and alloys such as aluminum alloys, coated with a protective coating against corrosion, such as a coating of a resin or polymer—for example, a Teflon™ coating; in further embodiments the plates may be powder coated with corrosion resistant layers of materials such as epoxies and polyurethanes. Filter plates are also described in U.S. Pat. Nos. 5,672,272 and 6,149,806 to William Baer and PCT International Publication Number WO 97/00171 to Dan Simpson et al., incorporated by reference in their entirety herein.

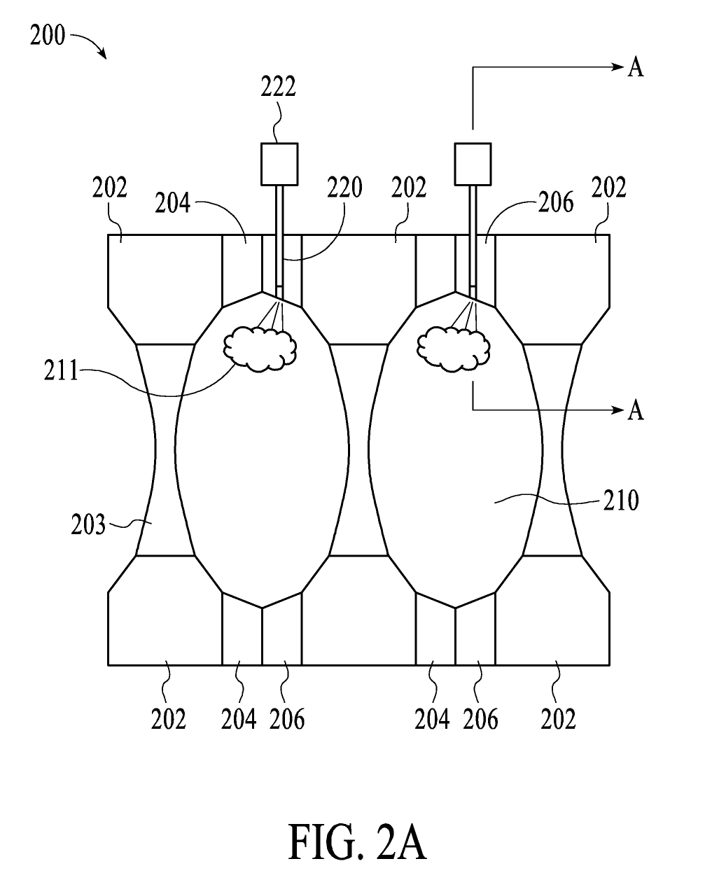

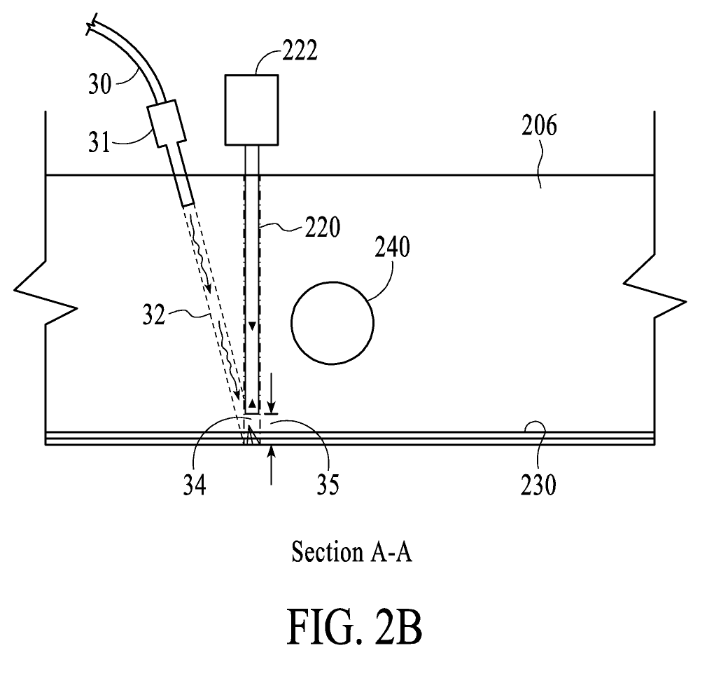

FIG. 2A shows a cross-sectional view of a block 200 of two adjacent filter chambers in the filter press. Each of the filter plates is shown to comprise a frame 202 around the periphery of the plate and a diaphragm 203 in the center of the plate. In some embodiments the filter plates are made of metal, such as aluminum alloy, the diaphragm is replaced by a rigid metal plate. In further embodiments, the filter plates are made of metal and the diaphragm is made of flexible sheets of metals such as stainless steel. Spacers 204 and 206 are positioned between adjacent filter plates in the stack in order to expand the width of the filter chamber 210—in embodiments the spacers may each be approximately 2 inches wide; filter plate frames may be manufactured with a large range of sizes, although it is expected that typical sizes may be 1000 mm, 1200 mm, 1500 mm and 2000 mm across (largest dimension). The spacers can be made of the same materials as described above for the filter plates. Furthermore, in embodiments one spacer may be used, in other embodiments more than 2 spacers may be used between adjacent plates. The difference between the spacers 204 and spacers 206 is that spacers 206 have a fluid inlet channel 32 (see FIG. 2B) permitting brine to be injected directly into the corresponding filter chamber. The brine is sprayed into the chamber 210 which is being vacuum pumped, water vapor is released from the brine and passes through the filter cloths lining the chambers and is removed from the filter press along the vacuum lines and is condensed in the condenser 42 and collected, as shown in FIGS. 1 & 2A; the brine spray cloud 211 is illustrated in FIG. 2A. Furthermore, in embodiments more than one fluid inlet channel may be integrated into a single spacer, and in embodiments more than one fluid inlet channel may be integrated into the spacers for a single chamber. The injection of brine is controlled by a solenoid 222 which runs in a separate channel 220 intersecting the inlet channel 32 before it reaches the filter chamber 210. FIG. 2B is a cross sectional view along A-A of the intersecting channels 32 and 220. The plumbing (fluid inlet line 30) for the brine is attached to an actuated valve 31 which is integrated into the spacer 206 at the inlet channel 32. The solenoid channel 220 is clearly seen to intersect the inlet channel 32, such that the solenoid 222 may be driven into the bottom end of the inlet channel 32 at the position 34 to provide control of the injection of brine into the filter chamber 210 (see FIG. 2A). In this example a one inch stroke solenoid is sufficient to control the brine injection, as indicated by the one inch gap 35 shown in FIG. 2B. FIG. 2B also shows a primary vacuum extraction port 240 (which connects with corresponding ports in the other plates and spacers in the filter plate stack), and a “T” groove 230 for mounting the filter cloth that lines the filter chamber. (The filter cloths are not shown in the figures; the filter cloths line the surfaces of the filter chambers 210 such that any fluids or gases escaping from the chamber must pass through filter cloth—clearly this permits removal of liquids and gases from the filter chamber while retaining precipitated salts and other solids. Furthermore, the filter cloth may be secured around the bottom of the inlet channel 32 using a plate or similar structure, so as to keep the injection outlet into the filter chamber free of any obstruction.)

Note that the filter cloths used for desalination may be chosen from a wide range of cloth types from coarse weave cloth to membrane cloth, depending on the type of contaminants in the water. For example, filter cloths may be made of polypropylene, stainless steel mesh, a combination of polypropylene and stainless steel mesh, etc.

With reference to FIG. 1, the system 100 operates by injecting brine 20 at elevated temperature and pressure into the chambers 15 of the vacuum filter press 10, and when the brine sprays into the chamber which is being vacuum pumped, water vapor is released and passes through the filter cloths lining the chambers and is removed from the filter press along the vacuum lines and is condensed in the condenser 42 and collected in reservoir 43 as shown. Some of the remaining liquids in the chamber will pass through the filter cloths and through ducts in the filter plates and are collected as shown—these liquids are referred to as filtrate 22. The precipitated salts remain in the filter chambers and are removed by opening the filter press—the filter plates are physically separated—and releasing the dry salts 24, as indicated by the arrows 23 in FIG. 1.

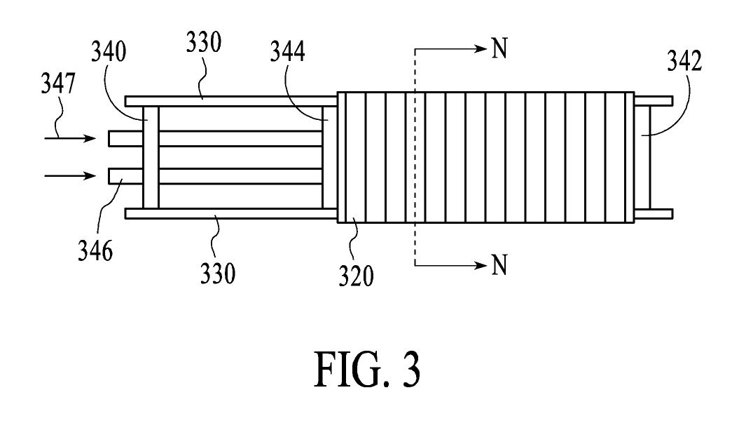

FIG. 3 shows a top view of a filter press 300, according to some embodiments of the present invention. The filter press 300 includes a stack of filter plates 320 mounted in a press comprising frame rails 330, on which the filter plates hang, fixed end plates 340 and 342, a movable plate 344, and rods 346 for applying a compressive force to the movable plate 344 as shown arrows 347 indicate force applied to end of rods distal to movable plate. Application of a compressive force to the movable plate 344 results in compressing the stack of filter plates 320. Associated with each filter plate are two spacers—one either side—which, for ease of illustration, are not shown in FIG. 3, but see FIG. 2A.

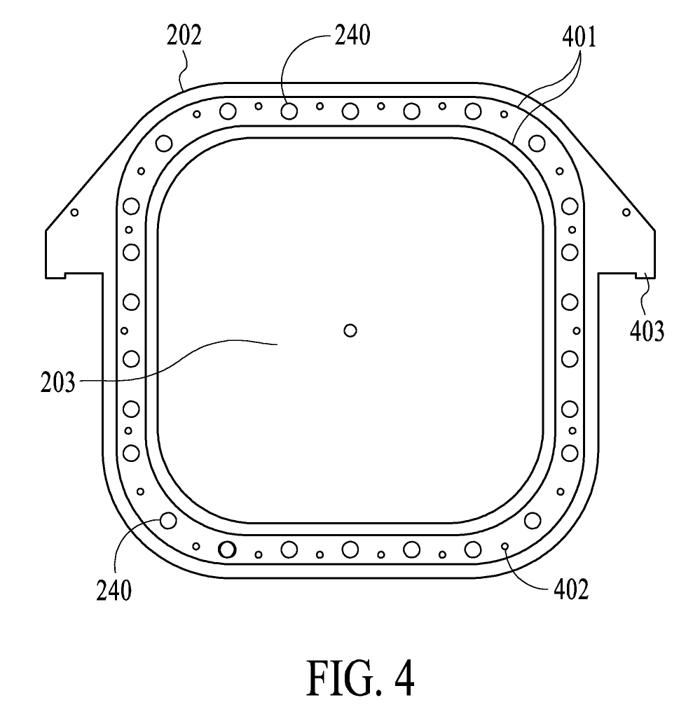

FIG. 4 shows a filter plate according to some embodiments. The filter plate comprises a frame 202 around the periphery of the plate and a diaphragm 203 in the center of the plate. (See also FIG. 2A.) The figure also shows handles 403 which are used to place the filter plate on frame rails 330 and may also be used to move the plates along the frame rails. (See FIG. 3.) Compression rings/flanges 401 are used to form a seal between adjacent filter plates/spacers. Each of the filter plates has a flange on a first side and a flat surface on the second side. When the flange of a first plate is brought into contact with the flat surface of an adjacent second plate or spacer and pressure is applied, a seal is formed between the first and second plates/spacers. Flanges are also used to provide isolation for the different ports around the periphery of the filter plate, thus ensuring that vacuum ports are isolated from filtrate ports, for example. Also shown are a plurality of bolt holes 402 which are used in embodiments for assembling the plates, spacers and stacks. FIG. 4 shows various ports 240 which are vacuum extraction ports—in this example the ports are 2.5 inches in diameter; the ports are situated around the periphery of the filter plate. These ports are apertures which extend completely through the filter plate and connect with the corresponding ports on the neighboring filter plates/spacers in the stack. In embodiments, the width of the frame 202 may be 8 3/16 inches, for example.

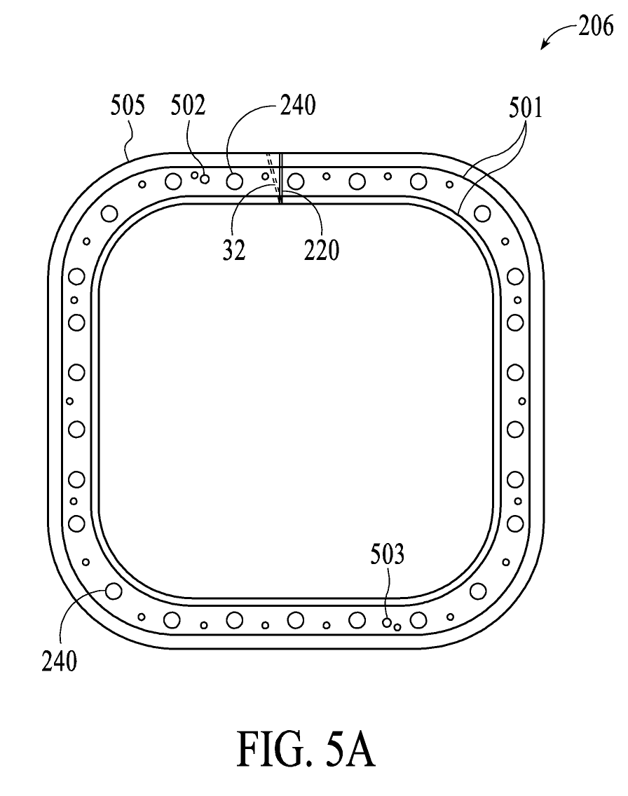

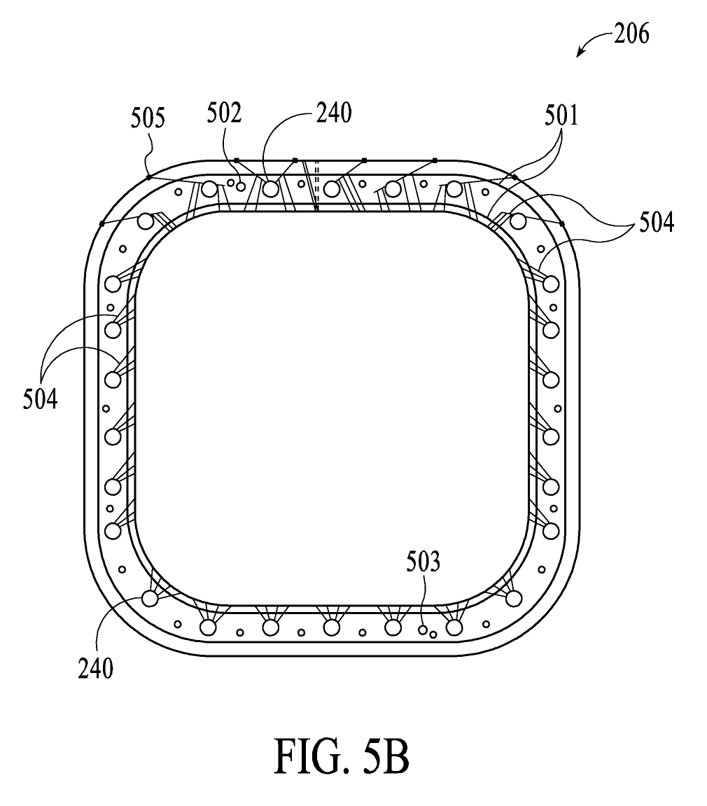

FIGS. 5A & 5B show a spacer 206, highlighting different features, according to some embodiments. The position of fluid inlet channel 32, which permits brine to be injected directly into the filter chamber, and intersecting channel 220, through which the solenoid moves to control the injection of brine into the filter chamber, are indicated in the figures. Compression rings 501 provide a seal with adjacent filter plates/spacers. The figures show various ports including primary vacuum extraction ports 240, steam ports 502 and condensate ports 503, the latter two ports are used if the filter plates are heated by passing steam through the stack (and through the filter plate diaphragms 203 where effective heat transfer to the contents of the filter chamber may occur); the ports are situated around the periphery of the filter plate. Furthermore, FIG. 5B indicates the position of secondary vacuum extraction ports 504, which are roughly ⅛ inch to ⅜ inch diameter holes drilled into the spacer connecting to the larger (roughly 2.5 inch diameter) primary vacuum extraction ports 240. The ports 504 are distributed around the inner circumference of the spacer and serve to connect the filter chamber to the main vacuum lines. Note that where vacuum extraction ports 504 have been fabricated by drilling through the spacer from the outside surface, then the ends of the ports are plugged with plugs 505 where the ports meet the outer circumference of the spacer. Furthermore, note that the extraction ports 504 are configured so as to reduce the chance of any condensed water vapor from running back along the vacuum lines and ports and back into the filter chamber.

Although the present invention has been described with reference to injectors and secondary vacuum extraction ports being formed in the spacers (due to an expectation of greater ease of manufacture of the parts), in embodiments either or both of these may be formed in the filter plate. Furthermore, in some embodiments one spacer attached to a filter plate may comprise the injector, and the other spacer may comprise the secondary vacuum extraction ports, again with a view to greater ease of manufacture.

Note that although some dimensions are provided on some of the figures, these dimensions are not intended to be limiting, and are merely provided as examples—for example, the filter plates, spacers and vacuum filter press may in embodiments be larger or smaller than specifically indicated in the figures. Furthermore, the various component parts of the filter plates, spacers and vacuum filter presses may be larger or smaller than shown in the figures or as specifically described elsewhere herein—for example, vacuum extraction ports and fluid inlet channels may in embodiments be larger or smaller than specifically indicated in the figures or described elsewhere herein.

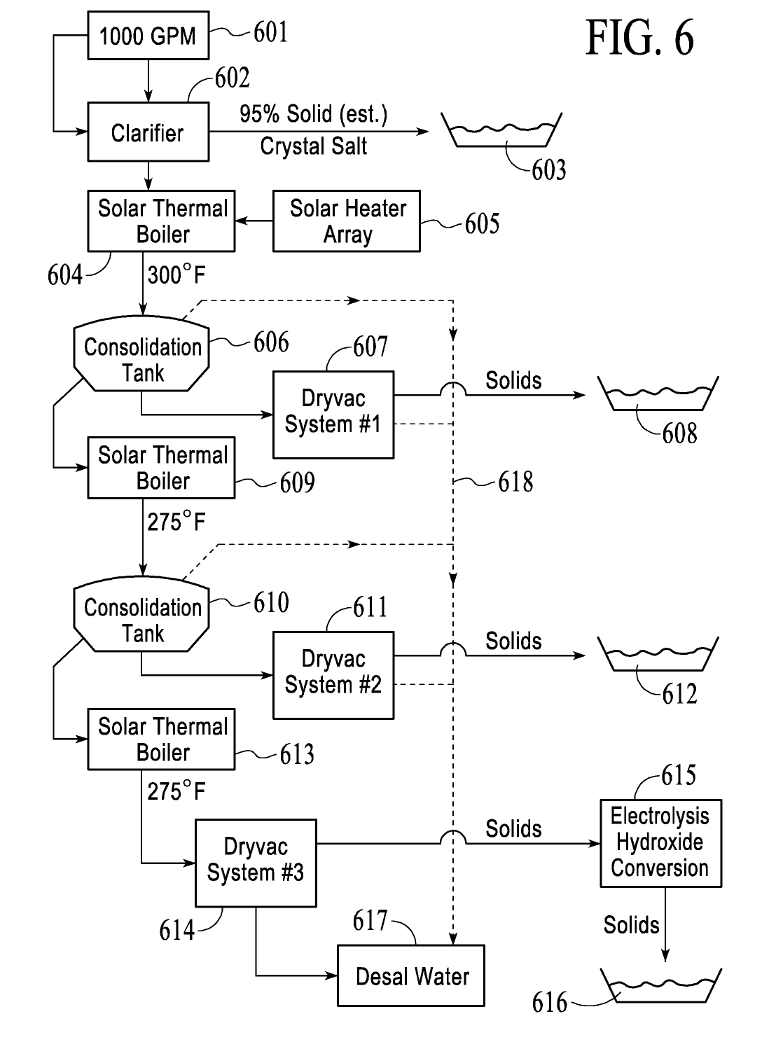

Filter presses according to embodiments of the present disclosure may be used for large scale desalination of geothermal brine, for example. FIG. 6 shows a schematic of an example of such a desalination plant for extraction of salts from geothermal brine. This brine comprises a number of salts that need to be collected separately, namely, in this particular example, potash, magnesium carbonate and lithium carbonate; the differing solubilities of the different salts are used to advantage to selectively precipitate the different salts by controlling the temperature of the brine during processing. The system of FIG. 6 is configured to input brine 601 at, for example, a rate of 1,000 gallons per minute and a temperature of typically 250° F. to 400° F. The lower solubility salts (primarily potash) are precipitated in a lamellar clarifier 602, or similar sub-system, passing on the remaining liquids through a first solar thermal boiler 603, to raise the temperature of the brine to 300° F., to a first consolidation tank 606 (where the temperature will be kept close to 300° F.—using extra heating by RF, microwave, heat exchanger, etc. if needed—or allowed to slowly drop in temperature a little, which may also include some level of extra heating) for removal of the remaining potash, the precipitated potash salts from the consolidation tank are processed in a first vacuum filter press 607 to provide dry potash 608. The liquid from the first consolidation tank is then pumped through a second solar thermal boiler 609, to raise the temperature of the brine to 275° F., to a second consolidation tank 610 (where the temperature will be kept close to 275° F.—using extra heating by RF, microwave, heat exchanger, etc. if needed—or allowed to slowly drop in temperature a little, which may also include some level of extra heating) for removal of magnesium carbonate, the precipitated magnesium carbonate salts from the second consolidation tank are processed in a second vacuum filter press 611 to provide dry magnesium carbonate 612. The liquid from the second consolidation tank is then pumped through a solar thermal boiler 613, to raise the temperature of the liquid to 275° F., to a third vacuum filter press 614, for extraction of lithium carbonate. The third vacuum filter press may be configured as described herein for injection of hot brine into high capacity filter chambers—the injection process leading to precipitation of lithium carbonate and release of steam; the desalinated water 617 may be collected and recycled and the lithium carbonate is dried in the press and released from the press as a dry lithium carbonate salt. In some embodiments the lithium carbonate salts may be electrochemically processed in a process system 615 to convert the salt into lithium hydroxide 616. The first and second vacuum filter presses used for drying salts may be vacuum filter presses such as described herein, (vacuum) filter presses as described in U.S. Pat. No. 8,535,542, filed Nov. 2, 2009, entitled Filter-Press with Integrated Radio Frequency Heating to Daniel J. Simpson et al., incorporated by reference in its entirety herein, or other suitable filter presses as determined by a person of ordinary skill in the art. Note that the solar thermal boilers 604, 609 and 613 may be coupled with solar heater arrays, such as array 605, for example, for heating the brine directly or through a heat exchanger in the solar thermal boiler.

Furthermore, the teaching and principles of the system described herein with reference to FIG. 6 may be applied to the design of systems for the extraction of different salts, minerals, etc., although all such systems will comprise at least one vacuum filter press configured as described herein for injection of hot brine into high capacity filter chambers.

In the embodiments described above, brine may be preheated by a solar boiler or similar before injecting it into the vacuum filter press. Should extra heating of the filter press be required then steam heating may be used, as also described above. Furthermore, in embodiments radio frequency heating may be used.

Radio frequency heating provides a potentially very efficient method of directly heating the brine within the filter press. This may be achieved by choosing a radio frequency for which the brine has strong absorption of the radio frequency energy and fabricating the filter press out of materials with weak radio frequency absorption at the chosen frequency. Direct heating of the brine also has the advantage of removing the need for indirect heating. For example, for desalination, there are frequencies for which brine is strongly absorbing and for which plastics materials/polymers, out of which filter plates may be made, are weakly absorbing.

An apparatus for dielectric heating at lower frequencies may include parallel metal plates with a changing potential difference applied at a frequency somewhere in the range of 1 to 100 megahertz; particular frequencies that have been set aside by the United States FCC for dielectric heating are 13.56, 27.12 and 40.68 MHz. Material is placed or moved between the parallel plates in order to be heated. Microwave heating of materials is a sub-category of dielectric heating within a frequency range of approximately 300 to 3000 MHz. A variety of radio frequency sources and apparatuses are described herein. However, other radio frequency sources and apparatuses operating within the frequency range from 1 MHz to 3 GHz may be used according to the principles and teaching of the present invention. U.S. Pat. No. 8,535,542, filed Nov. 2, 2009, entitled Filter-Press with Integrated Radio Frequency Heating to Daniel J. Simpson et al., incorporated by reference in its entirety herein, provides more details of radio frequency heating integrated into filter presses.

In general, microwave frequencies may be well suited for small filter presses and the lower frequencies may be well suited for large filter presses. This is due to the lower frequencies being more penetrating within the filter press. In general, small filter presses are used for high value products such as foodstuffs and pharmaceuticals, for example, and large filter presses are used for high volume processes, including desalination of brine. The use of radio frequency has a further advantage in that it is effective in destroying biological growths, pathogens and viruses.

Although the present invention has been described with reference to water desalination/salt extraction, the teaching and principles of the present invention are applicable to a wide variety of fluid purification processes. For example, the teaching of the present invention is applicable to purification of: salt water contaminated oil, for removal of both water and salts; salt water contaminated biodiesel fuels; waste water; sewer water; mining waste water; water based pigments, for separation of water and pigments; etc.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A vacuum filter press system comprising:
a frame;
a liquid injection system for controllably injecting liquid directly into each of a multiplicity of chambers;
a plurality of filter plates configured to form a stack of parallel plates, each of said plurality of filter plates being movably attached to said frame, said plurality of filter plates further being configured to form said multiplicity of chambers, each of said multiplicity of chambers being formed by adjacent filter plates of said plurality of filter plates, each of said multiplicity of chambers being lined by filter cloths, wherein said plurality of filter plates, said multiplicity of chambers and said filter cloths are configured to allow vapor to escape from said chambers while retaining solids from said liquid to form a filter cake; and
a vacuum pump connected to said multiplicity of chambers.

2. The vacuum filter press system of claim 1, wherein each of said plurality of filter plates has spacers attached to both sides, for enlarging the capacity of each of said multiplicity of chambers.

3. The vacuum filter press system of claim 2, wherein at least one of said spacers corresponding to each of said multiplicity of chambers comprises a first channel for injection of said liquid into the chamber, a second channel intersecting said first channel, and wherein a solenoid is configured in said second channel to control the amount of said fluid being injected into the chamber.

4. The vacuum filter press system of claim 2, wherein at least one of said spacers corresponding to each of said multiplicity of chambers comprises vacuum extraction ports for connecting said vacuum pump to the chamber.

5. The vacuum filter press system of claim 4, wherein said vacuum extraction ports comprise primary vacuum extraction ports which run from one adjacent filter plate or spacer to the next, and secondary vacuum extraction ports which connect said primary vacuum extraction ports to the chamber.

6. The vacuum filter press system of claim 5, wherein said secondary vacuum extraction ports intersect said primary vacuum extraction ports along the upper half of the circumference of said primary vacuum extraction ports for reducing back flow of condensed vapor from said primary vacuum extraction ports to the chamber.

7. The vacuum filter press system of claim 1, wherein said filter plates comprise aluminum alloy and wherein said filter plates are coated with a corrosion resistant layer.

8. The vacuum filter press system of claim 1, wherein said liquid injection system comprises a liquid supply line for each of said multiplicity of chambers, and wherein each of said supply lines has a valve for controlling the flow of said liquid.

9. The vacuum filter press system of claim 1, wherein said liquid is brine, said vapor is water vapor and said solids are salts.

10. A method of processing liquid in a filter press comprising:
providing a chamber between two filter plates in said filter press, said chamber being lined by filter cloths;
vacuum pumping said chamber;
during said vacuum pumping, controllably injecting liquid into said chamber causing solids to precipitate from said injected liquid and volatile components to be released in vapor form;
removing said vapor from said chamber by vacuum pumping, condensing said vapor and collecting said condensate; and
accumulating said solids in said filter chamber and releasing said solids from said filter chamber.

11. The method as in claim 10, wherein said liquid is brine, said vapor is water vapor, said condensate is water and said solids are salts.

12. A vacuum filter press system comprising:
a frame;
a plurality of filter plates configured to form a stack of parallel plates, each of said plurality of filter plates being movably attached to said frame, said plurality of filter plates further being configured to form a multiplicity of chambers, each of said multiplicity of chambers being formed by adjacent filter plates of said plurality of filter plates, each of said multiplicity of chambers being lined by filter cloths, wherein said plurality of filter plates, said multiplicity of chambers and said filter cloths are configured to allow vapor to escape from said chambers while retaining solids from said liquid to form a filter cake; and
a vacuum pump connected to said multiplicity of chambers;
wherein each of said plurality of filter plates has spacers attached to both sides, for enlarging the capacity of each of said multiplicity of chambers.

13. The vacuum filter press system of claim 12, wherein at least one of said spacers corresponding to each of said multiplicity of chambers comprises vacuum extraction ports for connecting said vacuum pump to the chamber.

14. The vacuum filter press system of claim 13, wherein said vacuum extraction ports comprise primary vacuum extraction ports which run from one adjacent filter plate or spacer to the next, and secondary vacuum extraction ports which connect said primary vacuum extraction ports to the chamber.

15. The vacuum filter press system of claim 14, wherein said secondary vacuum extraction ports intersect said primary vacuum extraction ports along the upper half of the circumference of said primary vacuum extraction ports for reducing back flow of condensed vapor from said primary vacuum extraction ports to the chamber.

16. The vacuum filter press system of claim 12, wherein said filter plates comprise aluminum alloy and wherein said filter plates are coated with a corrosion resistant layer.
